(19) United States
(12) Patent Application Publication
(10) Pub. No.: US 2006/0282403 A1
(43) Pub. Date: Dec. 14, 2006

(54) Selective collection, filtering and processing of transactions in multiple transaction classes

(75) Inventors: Kimberly J. Kroetsch, Fargo, ND (US); Samantha A. Britney, Seattle, WA (US); Karen D. Mullenberg, Fargo, ND (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/136,035

(22) Filed: May 24, 2005

(51) Int. Cl. G06F 17/30

(52) U.S. Cl. 707/2

(57) ABSTRACT

A computerized accounting system includes a setup-editing tool coupled to a group of query objects and to user input in a setup mode. The group of query objects defines the multiple transaction classes to be accessed, filtering criteria to filter out some of the selected transactions that are not to be included in a collection, and autoselection of user-defined data to be selected in the collection. A search tool couples to the group of query objects and to transactions in multiple classes in a search mode. The search tool provides user-defined search results in a data collection from multiple classes of transactions.

### BACKGROUND OF THE INVENTION

This invention relates to computerized business management applications and in particular to selectively collecting, filtering and processing transactions stored in such applications.

Computerized business management applications include data tables and database systems that are used to maintain business records of transactions and to facilitate execution of many business functions and transactions. Decision-makers frequently conduct multiple searches to collect data from multiple transactions with an objective to review the collected data in making an informed business decision for the enterprise.

In some cases, the search objective will correspond closely with a conventional transaction report that is part of the computerized business system. In these cases, the conventional report will automatically arrange and display transactions of a single transaction class and display calculated results based on the particular transactions displayed.

In other cases, however, the searches for transactions have objectives that are specialized for use in an individual business enterprise, or specialized for use by an individual decision-maker. For these more specialized searches, meeting the search objective requires separately querying or accessing a number of diverse classes of transactions, manually assembling and arranging the collected diverse classes of transactions, and manually calculating results based on the collected transactions.

One example of such a specialized search is a search that is generally defined as a search for “inventory status,” which includes such diverse transaction classes as freight receiving reports of inventory, internal requisitions of parts from inventory, reports of inventory losses, items on order for inventory, and scheduled future inventory requisitions. Another example of such a specialized search is a search that is generally defined as a search for “manufacturing cost trends,” which includes such diverse transaction classes as direct labor payments, indirect labor payments, material payments, supplies payments, machine maintenance charges and the like.

Yet another example of such a specialized search is a search which is generally defined as a search for liability transactions, which includes such diverse transaction classes as bills due to suppliers, refunds due to customers, dividend payments due to stockholders, taxes due, payments due to a bank on a line of credit, and other liability transactions that are due. With some liability transactions, the timing and/or amount of the transaction are discretionary. With some supplier liability transactions, terms discounts may be taken if a payment transaction is completed by a specified date thus reducing the amount of the liability and payment.

The timing and amount of payment of liability transactions is a critical financial management function that can impact many accounting areas such as savings from terms discounts, credit rating, liquidity and cash flow, and results reported in periodic financial reports. Timing of payments also influences relationships with suppliers, customers, lenders, shareholders and the investment community. Timing of payments can also be used to limit business risks or exert leverage in dealings and negotiations with suppliers and customers.

In the example of liabilities, financial managers periodically face a critical business decision in deciding what liabilities to pay. Various factors come into play based on each unique business, including cash flow, terms discounts, supplier priority, and currency exchange rates, just to name a few.

In less complex enterprises, the managerial decision-making processes supported by manual methods can be performed by mentally balancing trade-offs between various transaction classes. In the case of a small number of liability transactions, for example, mental processes and manual methods can be used to select some liability transactions to pay and other liability transactions to defer to a later date.

As the size and complexity of a business enterprise grows, however, manual processes to assemble and arrange transactions of different classes and manual calculation become prone to errors and omissions or ineffective decisions because of the diverse, complex characteristics of multiple classes of transactions considered in decision-making.

A method is needed that operates in conjunction with a computerized accounting system to support decision-making in display of specialized searches of business transactions from multiple classes to optimize decisions for the business enterprise.

### SUMMARY OF THE INVENTION

A computerized accounting system is disclosed. The accounting system comprises a computing environment including a database management system with a setup-editing tool and a search tool.

The accounting system further comprises a database that is accessed by the database management system. The database includes data files storing database transactions in multiple transaction classes. The database further includes a group of query objects.

The setup-editing tool couples to the group of query objects and to user input in a setup mode. The group of setup query objects identifies the multiple transaction classes to be accessed, filtering criteria to filter out some of the transactions returned by the query that are not to be included in a display, and autoselection of transactions returned by the query to be selected for inclusion in further processing.

The group of query objects couples to the search tool in a search mode. The search tool provides communication with the database and provides a collection of transactions from multiple transaction classes to the query objects.

In one embodiment, the object editing and search tools customize the objects to collect data from liability transactions in multiple classes such as payments due to suppliers and refunds due to customers. The user can execute a single search and obtain a data collection that combines data from the multiple classes of transactions in a single selective collection. The selective collection can be processed in the process mode to make payments.

### BRIEF DESCRIPTION OF THE DRAWINGS

FIG. 1 is a block diagram of one computing environment in which the present invention may be practiced.

FIG. 2 illustrates a computerized accounting system.

FIG. 3 illustrates executable instructions for performing steps in creating or editing setup query objects or query objects illustrated in FIG. 4.

FIG. 4 illustrates a group of related query objects that define a search for transactions in multiple transaction classes.

FIG. 5 illustrates computer executable instructions that perform steps during a search mode.

FIGS. 6A, 6B, taken together, illustrate a group of related query objects that define a search for payment of liability transactions in multiple classes and query objects for payment processing.

FIG. 7 illustrates computer executable instructions that define a search for liability transactions in multiple liability transaction classes.

FIG. 8 illustrates computer-executable instructions that define a process of validation and payment of liabilities.

### DETAILED DESCRIPTION OF ILLUSTRATIVE EMBODIMENTS

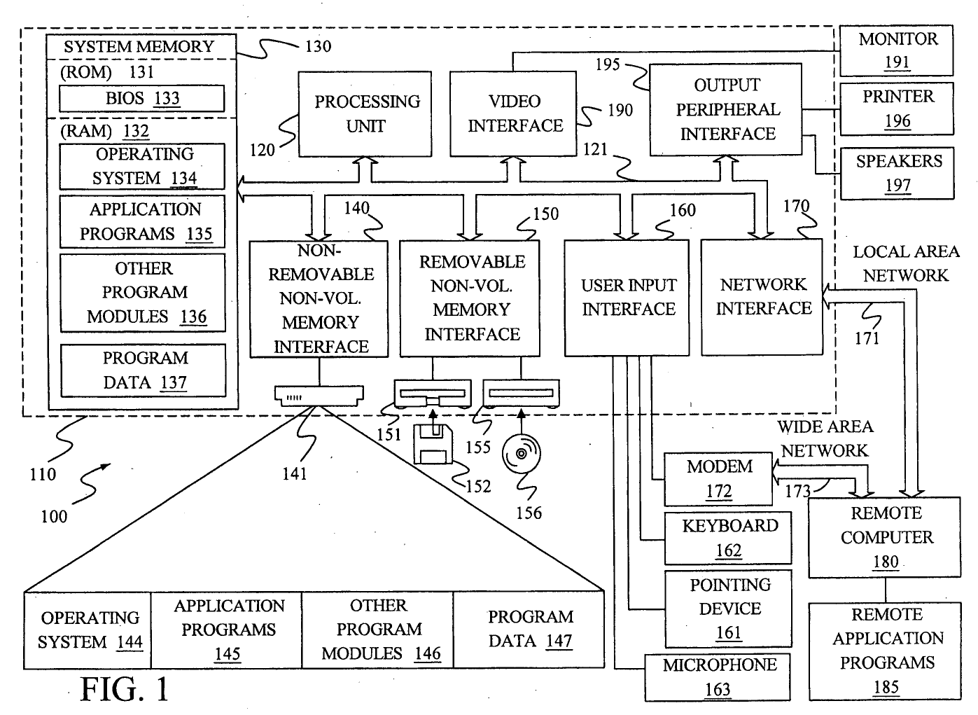

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention is designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

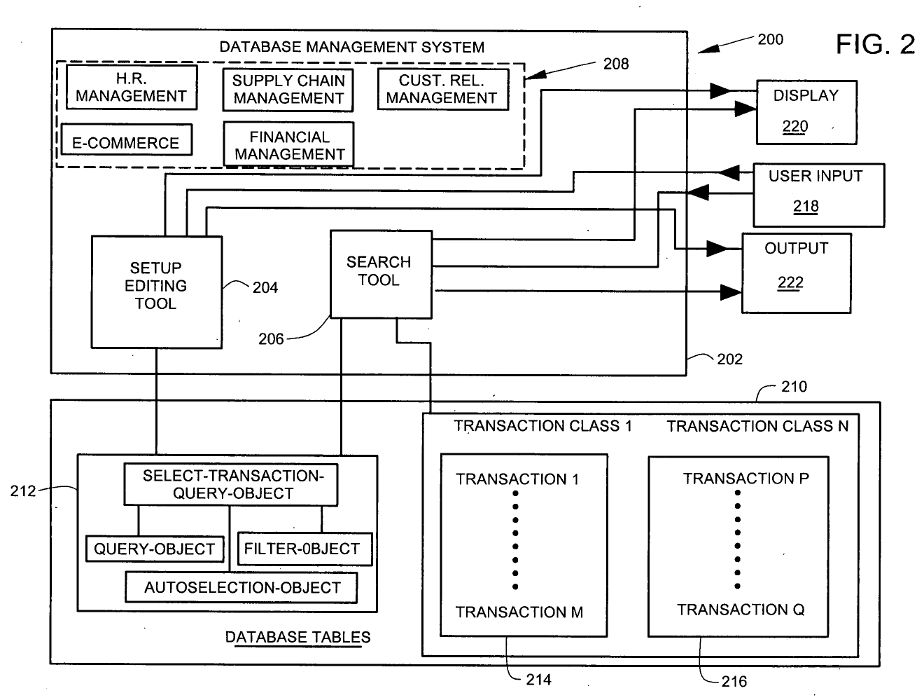

In the embodiments described below in connection with FIGS. 2-8, a user provides input to edit a group of query objects. The user provides user input to edit query objects to identify multiple transaction classes to be accessed, filtering criteria to filter out some of the transactions remaining after filtering that are not to be included in a collection of data, and autoselection of transactions returned by the query to be selected for inclusion in further processing.

In a search mode, the search tool accesses the query objects and database tables. The user starts the search by creating or selecting a specific group of query objects, and the search tool returns (provides) a collection of data from the transactions to the query objects. The collection of data can be displayed on a display screen, printed or provided to another application for further processing. The collection of data is pre-defined by the group of query objects and combines data from multiple transactions from different transaction classes into a single data collection. The combined data collection facilitates decision-making for the user.

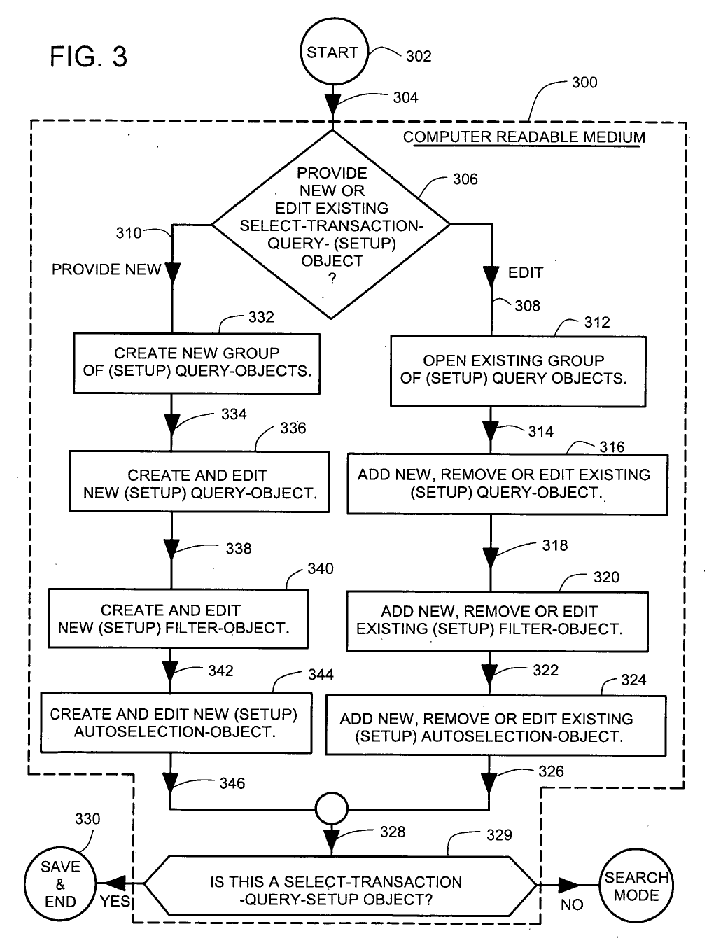

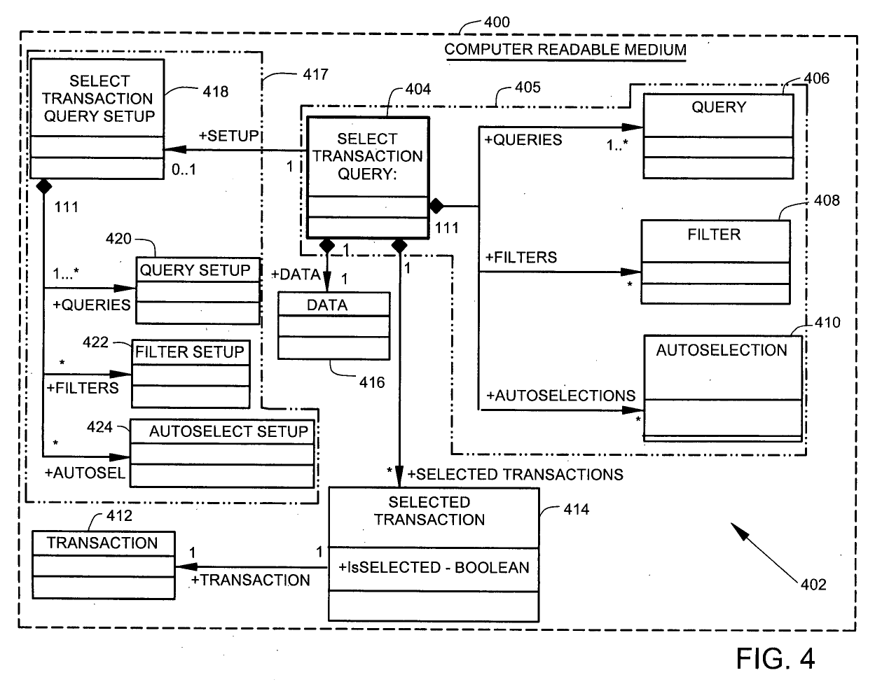

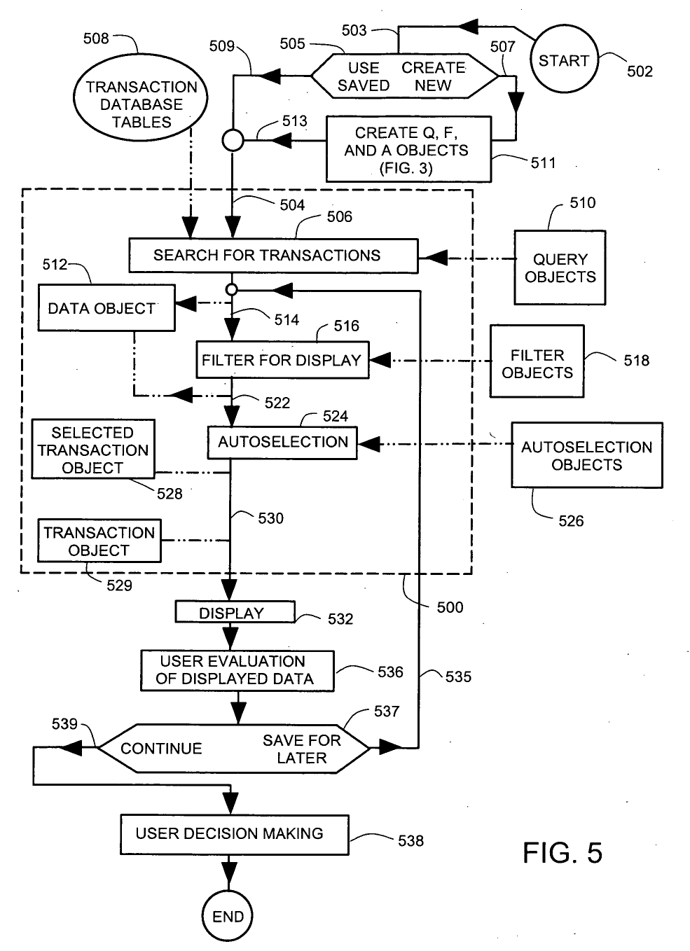

FIG. 2 illustrates a computerized accounting system 200 that can be implemented in a computing environment such as the computing environment illustrated in FIG. 1. The accounting system 200 includes a database management system 202 with a setup-editing tool 204 and a search tool 206. The setup-editing tool 204 is described in more detail below in connection with an example flow chart illustrated in FIG. 3. The search tool 206 is described in more detail below in connection with an example flow chart illustrated in FIG. 5. The database management system 202 can also include one or more of various other database management functions indicated generally at 208.

A database 210 is accessed by the database management system 202. The database 210 includes numerous data tables (data files) including multiple groups of query objects 212. A group of query objects is described in more detail below in connection with an example illustrated in FIG. 4. The database 210 also includes numerous transactions 214, 216 in multiple transaction classes such as transaction class 1 . . . transaction class N. Two transactions are in different transaction classes if the definitions of data fields in a first transaction are different than the definitions of data fields in a second transaction.

Upon command from a user input 218, the setup-editing tool 204 couples to one group of query objects selected from the groups of query objects 212. The setup-editing tool 204 also couples to a display 220, and to an output device 222. Using the setup-editing tool 204, a user is able to create or edit a custom search description for one particular specialized search objective. The particular specialized search objective is one of a group of search objectives such as a search for inventory status, or a search for outstanding liability transactions.

During a setup mode of operation, the user uses the setup-editing tool 204 to edit data stored in a group of setup query objects or query objects in order to define a custom strategy for identifying classes of transactions to be queried in search mode, to filter the transactions for display in search mode and to autoselect transactions in search mode for inclusion in a process mode of operation of the system 200. During the setup mode, the system 200 displays the input that the user enters into the group of query objects on a display 220. The system 200 can also direct the input entered in a group of query objects into an output device 222 such as a printer, a storage drive or a communication channel. This provides the user with a way of reviewing the user's particular search specification.

During a search mode, the search tool 206 obtains a search definition from the query objects 212. The search tool 206 searches through the transactions 214, . . . , 216 in multiple transaction classes (as defined by the query objects 212) to collect data as defined by the query objects 212. The search tool 206 provides search results (data collection) to the query objects 212 which in turn provide the results to the display 220. The group of query objects 212 identifies the multiple transaction classes to be accessed, filtering criteria to filter out some of the transactions returned by the query that are not to be included in the display 220, and autoselection of transactions returned by the query to be selected in the display 220 for inclusion in process mode.

A user of the system 200 will typically create a number of groups of setup query objects for later use. Each group of setup query objects defines all of the parameters of a particular search to be performed that spans across multiple transaction classes and that returns a display that encompasses data from the classes defined in the particular search. A particular search can be called up and run by the user at a later time, or searches can be set up to run on a prearranged schedule. The operation of the setup-editing tool 204 during the setup mode is described in more detail below in connection with FIG. 3.

FIG. 3 illustrates a computer-readable medium 300 that has computer executable instructions stored on it for performing steps for a setup-editing tool during a setup mode or a search mode. In FIG. 3, the computer executable instructions are represented as decision blocks and function blocks of a flow chart. Execution begins at start 302 and continues along line 304 to a decision block 306. At decision block 306, a decision is made, based on a choice indicated by the user, to either proceed along line 308 to open and edit a previously created (pre-existing) group of setup query objects (such as group 417 in FIG. 4) or query objects (such as group 405 in FIG. 4), or to proceed along line 310 to create a new (generally blank or default) group of setup query objects (such as group 417 in FIG. 4) or query objects (such as group 405 in FIG. 4) and then to edit the new group of setup query objects or query objects. Whether proceeding along line 308 or 310, a group of setup query objects or query objects is provided for editing to the user.

When editing an existing group of setup query objects or query objects, execution continues from decision block 306 along line 308 to function block 312. At function block 312, an existing group of setup query objects or query objects is opened for further editing.

Execution then continues along line 314 to function block 316 where a new query-setup-object or query-object is created, an existing query-setup-object or query-object is edited, or an existing query-setup-object or query-object is removed. The query-setup-object is linked to the select-transaction-query-object. The query-object is linked to the select-transaction-query-object. The query-setup-object or query-object is created, edited, or removed in response to user input, to identify the multiple transaction classes to search. In addition to allowing the user to create, edit, and remove query-objects, the query-objects can be defined by the application and unable to be edited by the user if warranted by the application.

After execution of function block 316, execution continues along line 318 to function block 320 where a new filter-setup-object or filter-object is created, an existing filter-setup-object or filter-object is edited, or an existing filter-setup-object or filter-object is removed. The filter-setup-object is linked to the select-transaction-query-setup-object. The filter-object is linked to the select-transaction-query-object. The filter-setup-object or filter-object is created, edited, or removed in response to user input, to define filtering criteria that filter out of some of the transactions that are not to be included in the display.

After execution of function block 320, execution continues along line 322 to function block 324 where a new autoselection-setup-object or autoselection-object is created, an existing autoselection-setup-object or autoselection-object is edited, or an existing autoselection-setup-object or autoselection-object is removed. The autoselection-setup-object is linked to the select-transaction-query-setup-object. The autoselection-object is linked to the select-transaction-query object. The autoselection-setup-object or autoselection-object is created, edited, or removed in response to user input, to define a set of rules to be applied to the transactions remaining after filtering to be selected for inclusion in process mode. The autoselection-setup-object or autoselection-object can be filter-based or logic-based (not defined by a filter).

After execution of function block 324, execution continues along lines 326, 328 to function block 330 where the editing of a pre-existing group of setup query objects or query objects completed in function blocks 312, 316, 320, 324 is saved or stored. It is understood that, throughout the processes illustrated ih FIG. 3, the user can execute a “delete” function to remove some or all details of objects. Other basic functions (such as “save”, for example) can also be performed by the user throughout the processes illustrated in FIG. 3. The storage at 330 completes operation in a setup mode, and the stored setup query objects or query objects in the selected group of setup query objects or query objects are available for later use in a search mode. The editing performed in function blocks 316, 320, 324 can be performed in the order shown, or in a different order.

Alternatively, execution can proceed from decision block 306 along line 310 when the user elects to open a new group of setup query objects or query objects for a newly defined search task. The new group of setup query objects or query objects can be blank or can include default values. Execution along line 310 continues to function block 332 where a new group of setup query objects (such as group 417 in FIG. 4) or query objects (such as group 405 in FIG. 4) is opened.

Execution then continues along line 334 to function block 336 where a new query-setup-object or query-object is created and edited. The query-setup-object is linked to the select-transaction-query-setup-object. The query-object is linked to the select-transaction-query-object. The query-setup-object or query-object is edited, in response to user input, to identify the multiple transaction classes that will be searched in search mode. In addition to allowing the user to create, edit, and remove query-objects, the query-objects can be defined by the application and unable to be edited by the user if warranted by the application.

After execution of function block 336, execution continues along line 338 to function block 340 where a new filter-setup-object or filter-object is created and edited. The filter-setup-object is linked to the select-transaction-query-setup-object. The filter-object is linked to the select-transaction-query-object. The filter-setup-object or filter-object is edited, in response to user input, to define filtering criteria that filter out of some of the transactions that are not to be included in the display.

After execution of function block 340, execution continues along line 342 to function block 344 where a new autoselection-setup-object or autoselection-object is created and edited. The autoselection-setup-object is linked to the select-transaction-query-setup-object. The autoselection-object is linked to the select-transaction-query. The autoselection-setup-object or autoselection-object is edited, in response to user input, to define a set of rules to be applied to the transactions remaining after filtering to be selected for inclusion in process mode. The autoselection-setup-object or autoselection-object can be filter-based or logic-based.

After execution of function block 344, execution continues along lines 346, 328 to function block 330 where the editing completed in function blocks 332, 336, 340, 344 is saved or stored. Alternatively, the user can opt (at decision block 329) to proceed to a search mode of operation. The storage completes operation in a setup mode for a new group of setup query objects or query objects, and the new stored group of setup query objects or query objects is available for use in a search mode. The group of setup query objects or query objects is described in more detail below in connection with an example illustrated FIG. 4.

FIG. 4 illustrates a computer-readable medium 400 having a data structure 402 stored on it. The data structure 402 comprises a group of related query objects that define a search specification for transactions that are in multiple transaction classes.

During setup mode, a user can design and save a search specification in a group 417 of setup query objects for later use. The group 417 of setup query objects serves as search specification that can be recalled at a later time to avoid re-entering a search specification. In the group 417, the objects 420, 422, 424 are bound to the object 418.

The search specification can be prepared during a setup mode, or can alternatively be defined at the beginning of a search mode and saved in the group 417 for reuse at a later time.

The group 417 comprises a select-transaction-query-setup-object 418. The select-transaction-query-setup-object 418 comprises a parent object (indicated by the symbol “♦”) that is linked in a parent-child relationship with child objects that include a query-setup-object 420, a filter-setup-object 422, and an autoselect-object 424.

When a search mode is started and the user specifies the group 417 as an initial search specification, then the search specification stored in group 417 is copied to a group 405 of objects 404, 406, 408, 410. The select-transaction-query-setup object is copied to the select-transaction-query object 404. The query-setup-object 420 is copied to the query-object 406. The filter-setup-object 422 is copied to the filter-object 408, and the autoselect-setup-object 424 is copied to the autoselection-object 410. Before beginning a search, the user can make changes to the search specification copied into objects 404, 406, 408, 410 to customize the search relative to the search specification stored in group 417. In the group 417, the objects 406, 408, 410 are bound to the object 404.

The select-transaction-query-object 404 defines the collection of transactions from multiple transaction classes in a business management database. The select-transaction-query-object 404 comprises a parent object (indicated by the symbols “♦”) that is linked in a parent-child relationship with a single data-object 416, the multiple query-objects 406, the multiple filter-objects 408, the multiple autoselection-objects 410, and a selected transaction object 414.

The query-objects 406 identify the multiple transaction classes to be searched and provides instructions to the database search engine to conduct multiple searches of multiple tables with field definitions structures that are different from one another. The data-object 416 is generated using the query-objects 406 during the search mode and comprises all of the transactions found in a search. The data-object 416 comprises a table-like structure to organize the transaction data returned from the search. The filter-objects 408 define filtering criteria that filter out of some of the multiple transactions contained in data-object 416 that are not to be included in the collection. The autoselection-objects 410 define a set of rules to be applied to the transactions contained in data-object 416 that are remaining after filtering to be selected for inclusion in process mode.

The selected-transaction object 414 is linked to a transaction-object 412. The transaction-object 412 is the object representation of the transaction in the business management system. The selected-transactions-object 414 is generated during the search mode and comprises all of the transactions selected by autoselection-object 410 or manual selection by user input. The selected-transaction-object 414 is linked to the select-transaction-query-object 404. The objects 406, 408, 410 define the parameters of a search, are set up by the user, and are stable during execution of the search. The objects 412, 414 and 416 are filled with data by running the search, and tend to be different each time a search is run in the search mode because new data is constantly being added to the accounting system. The search mode is described in more detail below in connection with an example illustrated in FIG. 5.

FIG. 5 illustrates a computer-readable medium 500 that has computer executable instructions stored on it for performing steps during a search mode. FIG. 5 illustrates executing a search defined by the select-transaction-query-object to produce a search result that includes the multiple transaction classes, and then the search result is filtered and stored in a selected-transaction-object that is linked to the select-transaction-query-object.

Execution flow begins at start 502 and continues along line 503 to decision block 505. At decision block 505, a user selects whether to create a new search definition, or whether to use a saved search definition (such as group 417 in FIG. 4). If the user decides at decision block 505 to use a saved search definition, then processing continues along lines 509 and 504 to action block 506. If the user decides at decision block 505 to create a new search definition, then processing continues along line 507 to action block 511. At action block 511, setup mode as defined in FIG. 3 is entered and new query, filter and autoselection objects are created, and then program flow continues along lines 513 and 504 to action block 506. The decisions and actions in blocks 505, 511 are described above in connection with FIG. 3.

Function block 506 searches through transactions of different classes stored in transaction database tables 508. The searches performed by function block 506 are defined by query-objects 510. The results of the searches performed by function block 506 are stored in a data-object 512.

Execution then continues along line 514 to a function block 516 which comprises filtering for displaying the collection. The function block 516 accesses transactions stored in the data-object 512 and also accesses filter-objects 518. The transactions remaining after filtering are designated as such in the data object 512 so the display shows collected transactions appropriately.

Execution then continues along line 522 to function block 524 which comprises autoselection of transactions collected for inclusion in process mode. The function block 524 accesses transactions stored in the data-object 512 and also accesses autoselection-objects 526. Each transaction autoselected for inclusion in process mode has a corresponding selected-transaction-object 528 created and a relationship is created between the transaction-object 529 and selected-transaction-object 528.

Execution then continues along line 530 to function block 532 which comprises display of the data-object 512 and selected-transaction-object 528 to the user. The function block 532 has access to the data stored in data-object 512, selected-transaction-object 528, filter-objects 518, and autoselection-objects 520.

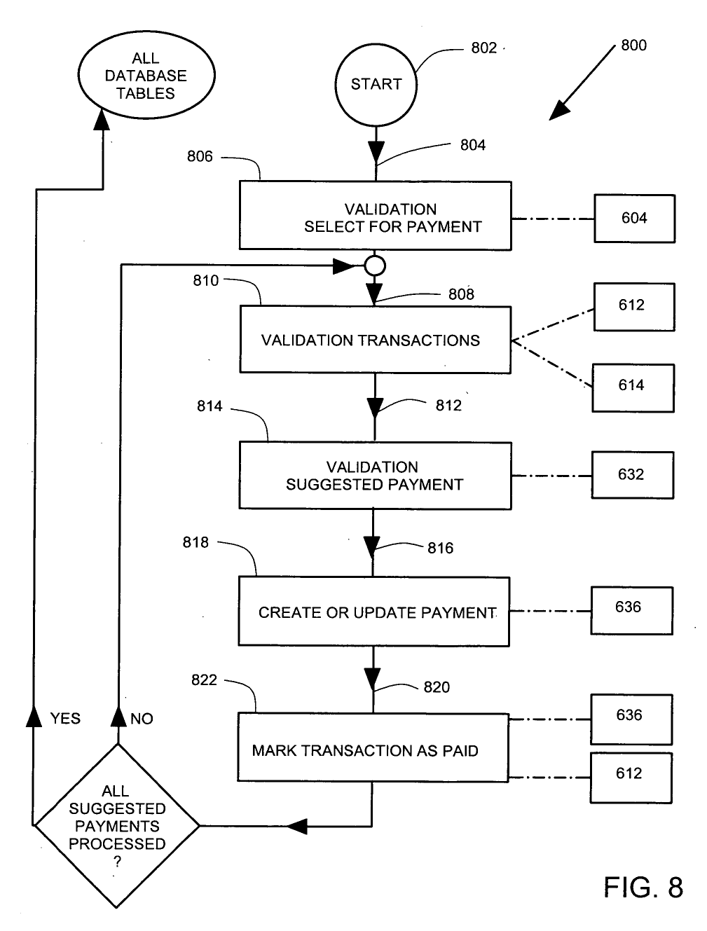

After the data is displayed, a user evaluates the displayed data at block 536. Data from multiple classes of transactions are displayed together in a single display with the filters and autoselections that compiled the scenario of processing the user is evaluating, allowing the user to contrast and compare different classes of transactions involved in the processing the user is working on. The user has the option to loop back to execution blocks 516 and 524 to change the filter-objects and autoselection-objects used to create a different set of data to evaluate in block 536. After the evaluation, flow continues to user decision making 538 where the user chooses to continue 539 to a process mode (as described below in connection with an example shown in FIG. 8) or saves (decision block 537) the amassed data to return to search mode or process mode at a later time.

Some or all of the steps stored on the computer-readable medium 500 can be automatically executed, if desired, according to an execution schedule.

A process mode is not specifically defined for the select-transaction-query-object. It would be defined by an object based on the select-transaction-query-object. The process mode can take a variety of forms depending on the type of data that are being processed and the different objectives of the user.

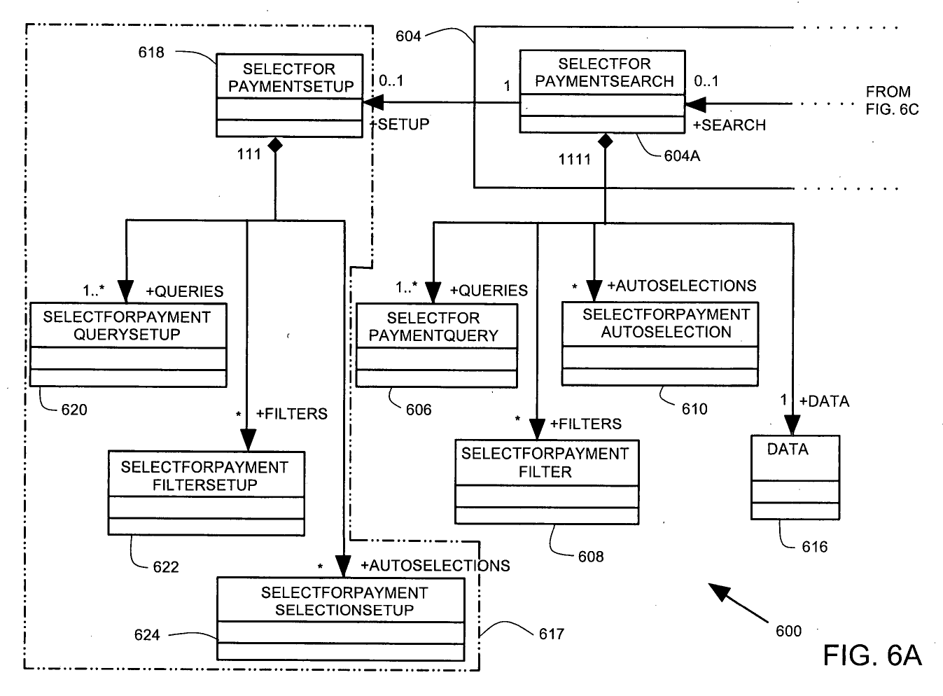

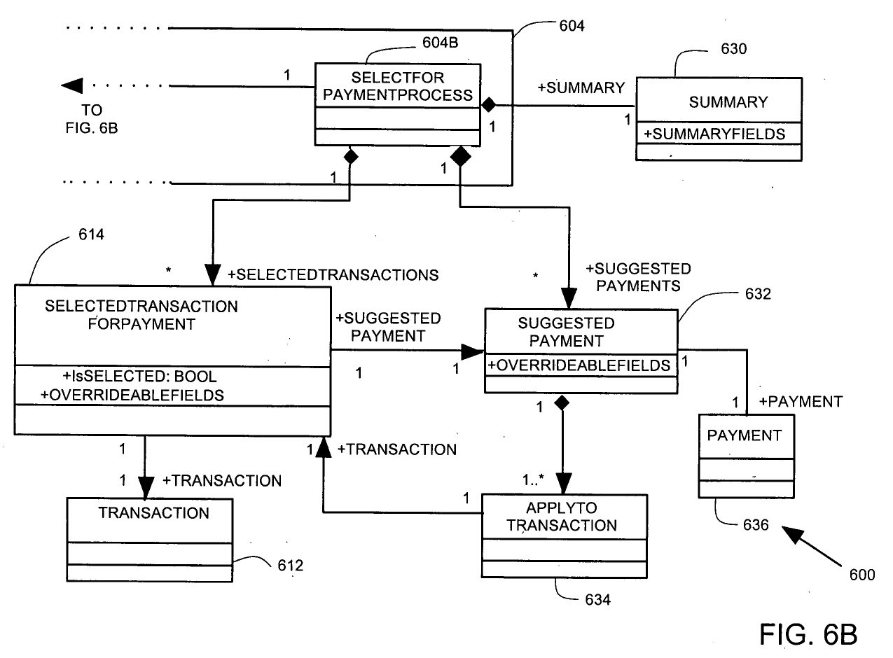

In the embodiments described below in FIGS. 6A, 6B, 7 and 8, a computerized “select transactions for payment” tool is presented for flexibly selecting, defining and grouping unpaid liabilities according to specified business enterprise needs. The “select transactions for payment” tool generates a combined collection of selected liabilities in a specified order to facilitate managerial decision making. The collection combines diverse classes of liabilities such as supplier invoices and customer refunds and other liabilities in a coherent manner such that a decision maker can readily identify opportunities and easily compare trade-offs between various “what if” payment scenarios. After a payment decision is made, the liabilities to be paid can be processed by the decision-maker for payment by the computerized accounting system.

Decision-makers can define their own liability payment criteria unique to their business, and encompass transactions from both accounts payable and accounts receivable. A single collection or list of selected transactions can also include both liabilities (Invoices, Liability Memos, Misc. Charges, etc.) and credits (Credits, Returns, pre-payments, etc.). Selected transactions from the list can then be processed by the accounting system to create payments. After the payments are created, the liabilities are marked as paid in the accounting system.

The functions of the “select transactions for payment” tool can be defined by the decision-maker to provide specific querying, filtering, and automatic selection of liabilities. The “select transactions for payment” tool combines both credit and debit transactions within the same processes and collections. Filtering and automatic selection can be based on data in any transactions classes included and either supplier or customer or other related data fields.

Unlimited business rules defined by the user can be used for automatic transaction selection such as using a budget, and setting minimum and maximum payment amounts can be included. Rules used during process mode such as “take expired discounts” and “add selected transactions to existing payments in the system” can be included.

User-overridable (editable) amounts from the selected transactions can include the discounts and payment amounts among other fields. There is an ability to view suggested payments to see how the selected transactions will be grouped together (“what if” scenarios). The user has the ability to make modifications to the suggested payments that will be reflected in the payments created through process mode, include changing the grouping options of the selected transactions, changing the payment method and changing the payment currency among other options. Summary fields are calculated automatically including counts of selected transactions and suggested payments as well as summary amounts for these collections.

FIGS. 6A-6B illustrate a computer-readable medium 600 having a data structure stored on it. The data structure comprises a group of related query objects that define a search for transactions (FIG. 6A) that are in multiple transaction classes and also payment processing (FIG. 6B). In FIGS. 6A, 6B, a select-transaction-query-object is represented as a select-for-payment-search-object 604A (FIG. 6A) and a select-for-payment-process-object 604B (FIG. 6B). FIGS. 6A and 6B can be joined together to form a complete object diagram.

FIGS. 6A, 6B specifically relate to a payment of liability transactions, and have certain similarities to FIG. 4 which relates to a search for transactions generally. 600-series reference numbers in FIGS. 6A, 6B that have two final digits corresponding with the same two final digits of 400-series reference numbers in FIG. 4 identify features that are similar in FIG. 4 and FIGS. 6A, 6B. For example, the select-transaction-query-object 404 in FIG. 4 is generally similar to the select-for-payment-object 604 in FIG. 6A, 6B, except that the select-for-payment-object 604 relates specifically to payment of liability transactions. The 600-series features are similar to the corresponding 400-series features, except that the 600 series features relate specifically to payment of liabilities. For the sake of brevity, descriptions of these 600 series features are not repeated herein.

Additionally, the data structure in FIGS. 6A, 6B includes a suggested-payment-object 632 that is linked to the select-for-payment-object 604. The selected-transaction-for-payment-object 614 is also linked to the suggested-payment-object 632. The data structure in FIG. 6A, 6B includes a summary-object 630 that is linked to the select-for-payment-object 604. An apply-to-transaction-object 634 is linked to the suggested-payment-object 632 and to the selected-transaction-for-payment-object 614 as illustrated. These additional objects 630, 632, 634 provide additional functionality to summarize transactions, provide additional display options, and provide support for a process mode (FIG. 8).

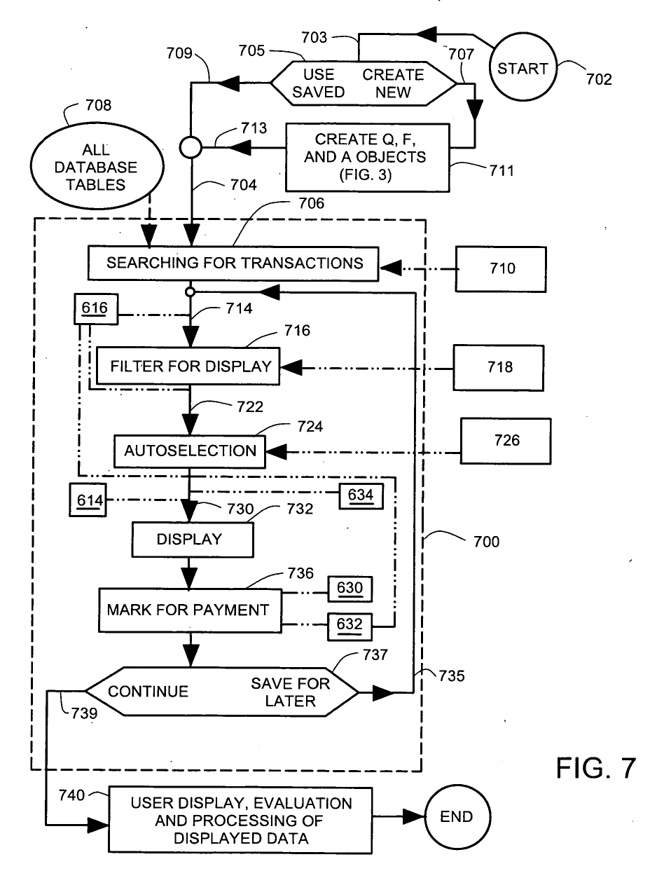

FIG. 7 illustrates a computer readable medium 700 that has computer executable instructions stored on it for performing steps of selecting liability transactions for payment during a search mode. FIG. 7 is similar to FIG. 5, but FIG. 7 illustrates a search mode specifically for payment of liabilities.

Execution flow begins at start 702 and continues along line 703 to decision block 705. At decision block 705, a user selects whether to create a new search definition, or whether to use a saved search definition (such as group 617 in FIG. 6A). If the user decides at decision block 705 to use a saved search definition, then processing continues along lines 709 and 704 to action block 706. If the user decides at decision block 703 to create a new search definition, then processing continues along line 707 to action block 711. At action block 711, setup mode as defined in FIG. 3 is entered and new query, filter and autoselection objects are created, and then program flow continues along lines 713 and 704 to action block 706. The decisions and actions in blocks 705, 711 are described above generally in connection with FIG. 3. Function block 706 searches through liability transactions of different classes stored in transaction database tables 708. The searches performed by function block 706 are defined by select-for-payment-query-objects 710. The results of the searches performed by function block 706 are stored in a data-object 616.

Execution then continues along line 714 to a function block 716 which comprises filtering for the collection. The function block 716 accesses transactions stored in the data-object 616 and also accesses select-for-payment-filter-objects 718. The transactions remaining after filtering are designated as such so the display shows the transactions appropriately.

Execution then continues along line 722 to function block 724 which comprises autoselection of transactions collected for inclusion in process mode. The function block 724 accesses transactions stored in data-object 616 and also accesses select-for-payment-autoselection-objects 726. Each transaction autoselected for inclusion in process mode has a corresponding selected-transaction-for-payment-object 614 created and a relationship is created between the selected-transaction-for-payment-object 614 and transaction-object 612. A suggested-payment-object 632 is created or an existing one is updated according data on the transaction selected and grouping options chosen by the user on select-for-payment-object 604. A corresponding apply-to-transaction-object 634 is created and a relationship is created between the apply-to-transaction-object 634 and the selected-transaction-for-payment-object 614. A relationship is created between the selected-transaction-for-payment-object 614 and the suggested-payment-object 632.

Execution then continues along line 730 to function block 732 which comprises collection of the data-object 616 and selected-transaction-for-payment-object 614 for display to the user. The function block 732 has access to the data stored in data-object 616, selected-transaction-for-payment-object 614, suggested-payment-object 632, summary-object 630, select-for-payment-filter-object 608, 718, and select-for-payment-autoselection-object 610, 726.

After the data is collected and displayed, a user evaluates the displayed data at block 736. Data from multiple classes of transactions are displayed together in a single display with the filters and autoselections that compiled the liability transactions to pay that the user is evaluating, allowing the user to contrast and compare different classes of transactions involved in the payment of liabilities and to manually choose to select additional unselected transactions or unselect already selected transactions. The user has the option to loop back along line 735 to execution blocks 716 and 724 to change the select-for-payment-filter-objects and select-for-payment-autoselection-objects used to create a different set of displayed and selected transactions to evaluate in block 732. After the evaluation is complete, flow continues along line 739 from decision block 737 to action block 740 where the user chooses to continue to process mode.

The select-for-payment-object 604 can be saved for the user to return to at a later time to continue working. In this case, the data-object 616 is discarded and the remaining object data is saved to the database. On returning to the select-for-payment-object 604 that was saved, flow of execution resumes at execution block 706 and continues through block 716 and then skips to block 732. As required by the changes to the reassembled data-object 616, the selected-transaction-for-payment-object 614, suggested-payment-object 632, apply-to-transaction-object 612, and summary-object 630 are updated or removed accordingly.

The select transactions for payment query described in FIGS. 6-7 is just one example of a select transactions query.

FIG. 8 illustrates a computer-readable medium 800 that has computer executable instructions stored on it for performing steps during a process mode. FIG. 8 illustrates executing a process to pay liability transactions selected from search mode on the select-for-payment-object.

Execution flow begins at start 802 and continues along line 804 to function block 806. Function block 806 validates the information on the select-for-payment-object 604 for correctness to allow process mode to execute.

Execution then continues along line 808 to function block 810. For the first suggested-payment-object 632, function block 810 validates the information on all transaction-objects 612 related to it via its relationship to apply-to-transaction-object 634 and selected-transaction-for-payment-object 614 for correctness to allow them to be paid.

Execution then continues along line 812 to function block 814. For the same suggested-payment-object 632 that was evaluated in function block 810, the suggested-payment-object itself is validated for correctness to allow a payment to be created or updated according to its information.

Execution then continues along line 816 to function block 818. For the same suggested-payment-object 632 that was evaluated in function blocks 810 and 814, a new payment-object 636 is created or an existing payment-object 636 is searched for and if found updated based on the process mode instruction set on the parent select-for-payment-object 604.

Execution then continues along line 820 to function block 822. For the same suggested-payment-object 632 that was evaluated in function blocks 810 and 814 and the transaction-objects 612 evaluated in function block 810, the process is initiated to select the transaction-objects 612 and the payment-object 636 as applied (paid). The result of this processing is saved to the database.

Execution then loops back and executes function blocks 810, 814, 818, and 822 for each suggested-payment-object 632 related to the select-for-payment-object 604.

In an alternative arrangement, the object model can split out so each “mode” has its own head object linked to its previous mode's head object.

Although the present invention has been described with reference to particular embodiments, workers skilled in the art will recognize that changes may be made in form and detail without departing from the spirit and scope of the invention.

What is claimed is:

1. A computer-readable medium having computer executable instructions for performing steps comprising:
(a) providing a select-transaction-query-object that binds together querying, filtering and autoselection properties for assembling a collection of transactions in multiple transaction classes;
(b) providing a query-object that is bound to the select-transaction-query-object, and that receives query criteria for selectively returning transactions in multiple transaction classes to the collection;
(c) providing a filter-object that is bound to the select-transaction-query-object, and that receives user-defined filtering criteria for filtering out transactions in multiple transaction classes from the collection returned by the query; and
(d) providing an autoselection-object that is bound to the select-transaction-query-object, and that receives user-defined rules to select transactions in the collection and make a selected collection of transactions in multiple transaction classes available for processing in a process mode.

2. The computer-readable medium of claim 1 wherein the autoselection-object includes filters.

3. The computer-readable medium of claim 1 wherein the autoselection-object includes logic.

4. The computer-readable medium of claim 1 having further computer-executable instructions for performing the steps of:
(e) executing a search defined by the select-transaction-query-object to produce the selected collection; and
(f) storing the selected collection in a data-object that is linked to the select-transaction-query-object.

5. The computer-readable medium of claim 4 wherein the selected-transaction-object is linked to the select-transaction-query-object and corresponds to a transaction that was selected by the autoselection-object or manually selected by the user links to a transaction-object that represents the transaction that was selected from the data-object.

6. The computer-readable medium of claim 4 having further computer-executable instructions for performing the steps of:
(g) automatically executing steps (e) and (f) according to an execution schedule.

7. The computer-readable medium of claim 4 wherein the multiple transactions comprise transactions stored in an accounting database that is a part of the business management database.

8. The computer-readable medium of claim 7 having further computer-executable instructions for performing the step of:
(g) selecting transactions in the search result, in response to user input, for inclusion in process mode.

9. A computer-readable medium having stored thereon a data structure comprising:
(a) a select-transaction-query-object that binds together querying, filtering and autoselection properties for assembling a collection of transactions in multiple transaction classes;
(b) a query-object that is bound to the select-transaction-query-object, and that receives query criteria for selectively returning transactions in multiple transaction classes to the collection;
(c) a filter-object that is bound to the select-transaction-query-object, and that receives user-defined filtering criteria for filtering out transactions in multiple transaction classes from the collection returned by the query; and
(d) an autoselection-object that is bound to the select-transaction-query-object, and that receives user-defined rules to select transactions in the collection and make a selected collection of transactions in multiple transaction classes available for processing in a process mode.

10. The computer-readable medium of claim 9 wherein the autoselection-object includes filters.

11. The computer-readable medium of claim 9 wherein the autoselection-object includes logic.

12. The computer-readable medium of claim 9 wherein the data structure further comprises:
(e) a selected-transactions-object that is linked to the select-transaction-query-object and corresponds to a transaction that was autoselected by the autoselection-object or manually selected by the user links to a transaction-object that represents the transaction that was selected from the data-object.
(f) a transaction-object that is linked to the selected-transaction-object that represents a selected transaction from the data-object.

13. The computer-readable medium of claim 9 wherein the multiple transactions comprise outstanding liability transactions stored in an accounting database that is a part of the business management database.

14. The computer-readable medium of claim 9 wherein at least one of the multiple transactions is a liability transaction selected from the group consisting of: payments due to suppliers, refunds due to customers.

15. The computer-readable medium of claim 14 having further computer-executable instructions for performing the step of:
(g) selecting liability transactions in the search result, in response to user input, for inclusion in process mode.

16. A computerized accounting system, comprising:
(a) a computing environment including a database management system with a setup-editing tool and a search tool;
(b) a database that is accessed by the database management system, the database including data files storing database transactions in multiple transaction classes, and the database including a group of query objects;
(c) the setup-editing tool coupling to the group of query object and to user input in a setup mode; and
(d) the group of query objects coupling to a search tool in a search mode, the search tool providing communication with the database and provides results to the query objects to provide to a data collection in multiple transaction classes, the group of query objects defining the multiple transaction classes to be accessed, filtering criteria to filter out the transactions that are not to be included in the collection, and autoselection of transactions to be selected in the collection.

17. The system of claim 16, wherein the group of query objects comprises:
(e) a select-transaction-query-object that binds together querying, filtering and autoselection properties for assembling a collection of transactions in multiple transaction classes;
(f) a query-object that is bound to the select-transaction-query-object, and that receives query criteria for selectively returning transactions in multiple transaction classes to the collection;
(g) a filter-object that is bound to the select-transaction-query-object, and that receives user-defined filtering criteria for filtering out transactions in multiple transaction classes from the collection returned by the query; and
(h) an autoselection-object that is bound to the select-transaction-query-object, and that receives user-defined rules to select transactions in the collection and make a selected collection of transactions in multiple transaction classes available for processing in a process mode.

18. The system of claim 17 wherein at least one of the multiple transactions is a liability transaction selected from the group consisting of: payments due to suppliers, refunds due to customers.

19. The system of claim 18 wherein the group of query objects further comprises:
(h) a selected-transactions-object that is linked to the select-transaction-query-object and corresponds to a transaction that was autoselected by the autoselection-object or manually selected by the user links to a transaction-object that represents the transaction that was selected from the data-object.
(i) a transaction-object that is linked to the selected-transaction-object that represents a selected transaction from the data-object.

20. The system of claim 19 wherein the data collection from a search is saved as a saved search.

21. The system of claim 20 wherein the saved search is opened and used in a process mode.

22. The system of claim 20 wherein the saved search is opened and used in a search mode.
